(19) United States
(12) Patent Application Publication
(10) Pub. No.: US 2019/0173180 A1
(43) Pub. Date: Jun. 6, 2019

(54) WIRELESS COMMUNICATION DEVICE AND ANTENNA DEVICE

(71) Applicant: FUJITSU LIMITED, Kawasaki-shi (JP)

(72) Inventor: Manabu Kai, Yokohama (JP)

(73) Assignee: FUJITSU LIMITED, Kawasaki-shi (JP)

(21) Appl. No.: 16/194,665

(22) Filed: Nov. 19, 2018

(30) Foreign Application Priority Data
Dec. 5, 2017 (JP) 2017-233535

(51) Int. Cl. H01Q 7/00; H01Q 7/02; H01Q 13/16

(52) U.S. Cl. CPC H01Q 7/005; H01Q 13/16; H01Q 7/02

(57) ABSTRACT

A wireless communication device includes a loop antenna that includes first to fourth terminals, the loop antenna having a first inductance, a first communication circuit that is coupled between the first and third terminals and has a first impedance, the first communication circuit resonating at a first frequency with the loop antenna, a coil that is coupled between the second and fourth terminals and has a second inductance higher than the first inductance, a capacitance that is coupled between the second and fourth terminals in parallel to the coil and has an electrostatic capacitance having a complex conjugate relationship with a second inductance of the coil, and a second communication circuit that is coupled between the second and fourth terminals and has a second impedance lower than the first impedance, the second communication circuit performing a communication at a second frequency via the loop antenna.

### CROSS-REFERENCE TO RELATED APPLICATION

This application is based upon and claims the benefit of priority of the prior Japanese Patent Application No. 2017-233535, filed on Dec. 5, 2017, the entire contents of which are incorporated herein by reference.

### FIELD

The embodiment discussed herein is related to a wireless communication device and an antenna device.

### BACKGROUND

Up to now, a wireless communication device provided with a dielectric including one principal surface and another principal surface, a rectangular coil antenna which is formed on the one principal surface of this dielectric and to which an IC chip for the coil antenna is electrically connected, and a monopole antenna which is formed on the one principal surface or the other principal surface of the dielectric on an outer circumference of winding constituting this coil antenna and which is grounded by the coil antenna has been proposed.

The wireless communication device is further provided with an IC chip for the monopole antenna to which power is supplied by this monopole antenna and a winding bending portion which is part of the winding constituting the coil antenna and in which the winding constituting the coil antenna is bend onto an inner circumference side (for example, see Japanese Laid-open Patent Publication No. 2011-128956).

### SUMMARY

According to an aspect of the embodiments, a wireless communication device includes a loop antenna that includes a first terminal and a second terminal, and a third terminal and a fourth terminal respectively corresponding to the first terminal and the second terminal, the loop antenna constituting a loop between the first terminal and the second terminal and the third terminal and the fourth terminal, and the loop antenna having a first inductance, a first communication circuit that is coupled between the first terminal and the third terminal and has a first impedance, the first communication circuit resonating at a first frequency with the loop antenna, a coil that is coupled between the second terminal and the fourth terminal and has a second inductance higher than the first inductance, a capacitance that is coupled between the second terminal and the fourth terminal in parallel to the coil and has an electrostatic capacitance having a complex conjugate relationship with a second inductance of the coil, and a second communication circuit that is coupled between the second terminal and the fourth terminal and has a second impedance lower than the first impedance, the second communication circuit performing a communication at a second frequency via the loop antenna.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a wireless communication device according to an embodiment;

FIG. 2 illustrates a configuration in which a cover portion is removed from the wireless communication device illustrated in FIG. 1;

FIG. 3 illustrates a configuration in which part of components is removed from the wireless communication device;

FIG. 4A illustrates part of the components of the wireless communication device;

FIG. 4B illustrates part of the components of the wireless communication device;

FIG. 5 illustrates an inlay;

FIG. 6 illustrates an element;

FIG. 7 illustrates an equivalent circuit of the wireless communication device as a radio frequency identifier (RFID) tag;

FIG. 8 illustrates an equivalent circuit of the wireless communication device as a Bluetooth Low Energy (BLE) communication device;

FIG. 9 illustrates a simulation model of the wireless communication device;

FIG. 10 is a Smith chart illustrates an impedance characteristic in a case where the wireless communication device functions as the RFID tag;

FIG. 11 is a Smith chart illustrates an impedance characteristic in a case where the wireless communication device functions as the BLE communication device;

FIG. 12 illustrates a wireless communication device according to a first modified example of the embodiment; and

FIG. 13 illustrates a wireless communication device according to a second modified example of the embodiment.

### DESCRIPTION OF EMBODIMENTS

A wireless communication device in related art is compatible with both a radio frequency identifier (RFID) system in a low frequency (LF) band or a high frequency (HF) band and an RFID system in an ultra-high frequency (UHF) band.

Both the RFID system in the LF band or the HF band and the RFID system in the UHF band include an integrated circuit (IC) chip. That is, for example, an impedance of an antenna when viewed from a terminal for connecting the IC chip of the RFID system in the LF band or the HF band is connected is several thousands of Q, and the impedance of the antenna when viewed from a terminal to which the IC chip of the RFID system in the UHF band is connected is also several thousands of Q.

In this manner, since the impedances of the antennas used in the two RFID systems are close to each other, it is relatively easy to cause the single wireless communication device to be compatible with both the two RFID systems.

On the other hand, it is difficult to be compatible with both a function as an RFID tag and a function as a communication device based on Bluetooth Low Energy (BLE) (registered trademark), Wifi, or a low power wide area (LPWA). While the impedance of the antenna of the RFID tag several thousands of Ω, an inductance of the antenna of the communication device based on BLE, Wifi, or LPWA is 50Ω, and the impedances largely vary.

The above Japanese Laid-open Patent Publication No. 2011-128956 does not disclose a solution to a case where the impedances largely vary as described above.

Hereinafter, an embodiment of a technology with which a plurality of communications in which the impedances largely vary may be performed will be described.

### Embodiment

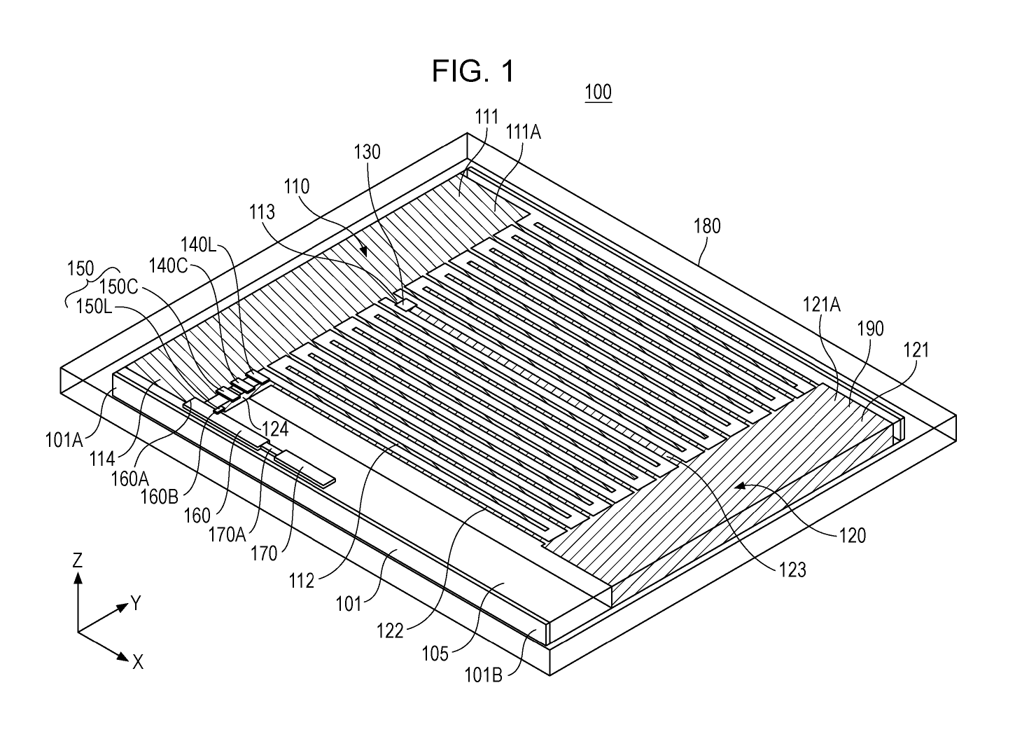

FIG. 1 illustrates a wireless communication device 100 according to the embodiment. The wireless communication device 100 includes a base portion 101, a sheet portion 105, antenna elements 110 and 120, an IC chip 130, a coil 140L, a capacitance 140C, a matching circuit 150 (a coil 150L and a capacitance 150C), a communication portion 160, a battery 170, and a cover portion 180. The wireless communication device may be referred to as a wireless communication tag.

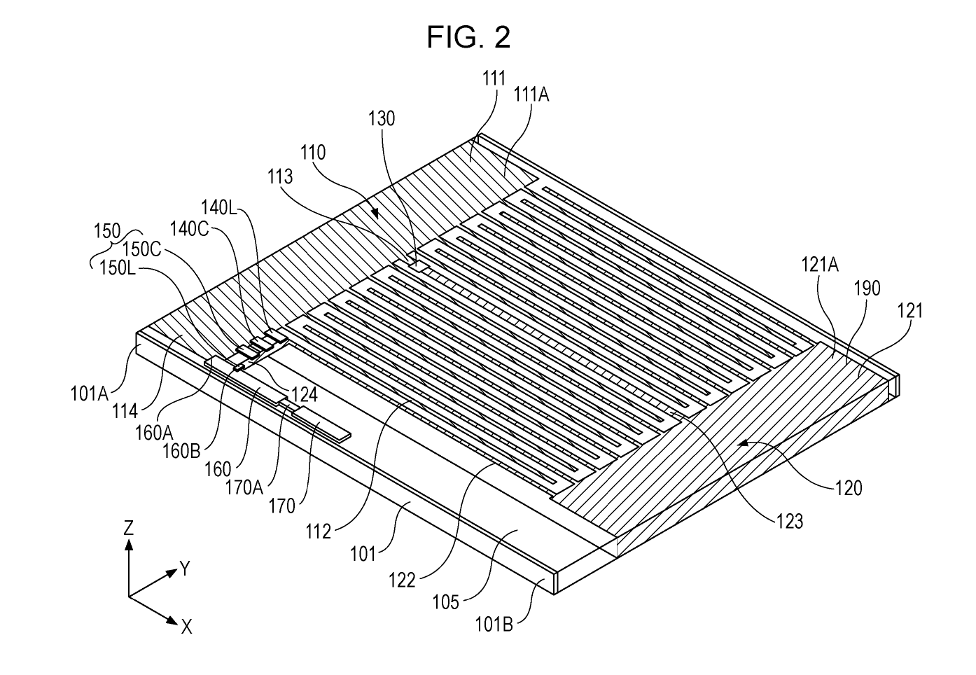

Hereinafter, a configuration of the wireless communication device 100 will be described with reference to FIG. 2 to FIG. 6 in addition to FIG. 1. In FIG. 1 to FIG. 6, a common XYZ coordinate system is defined.

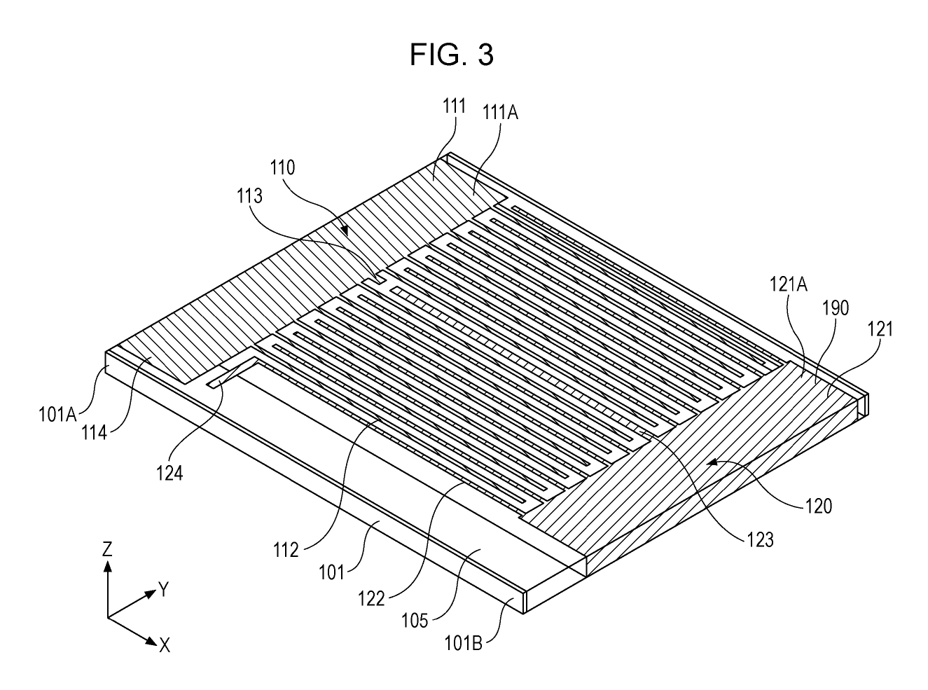

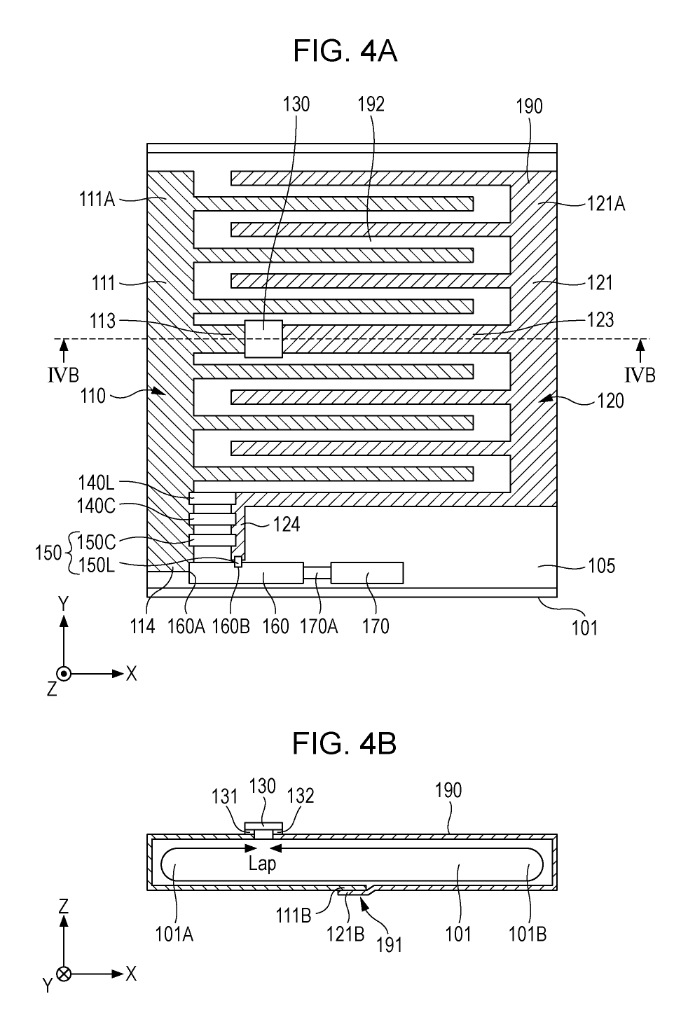

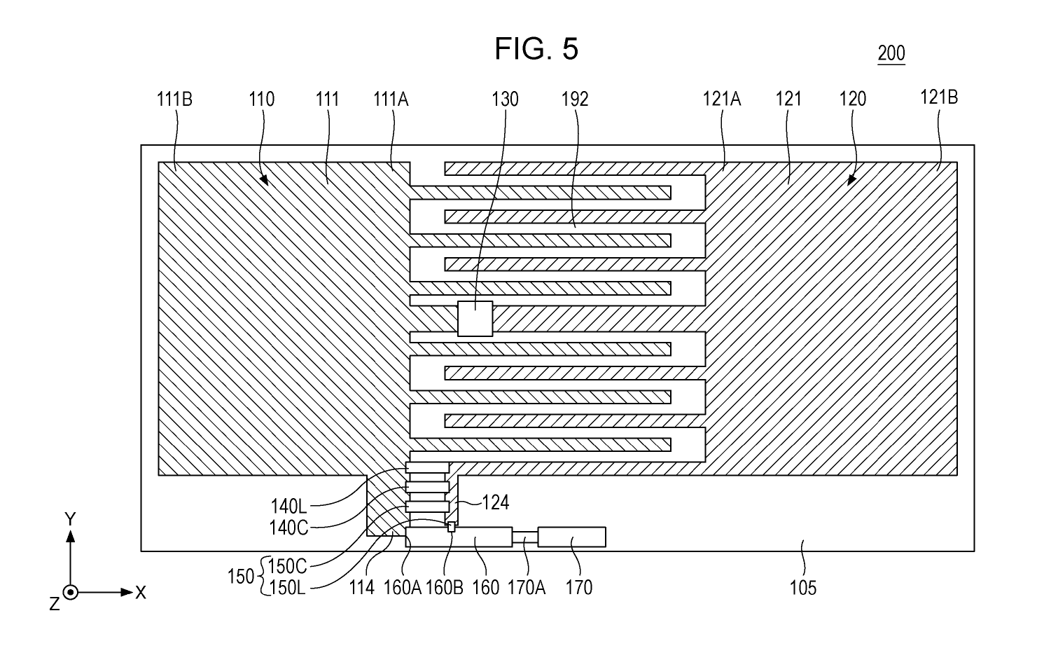

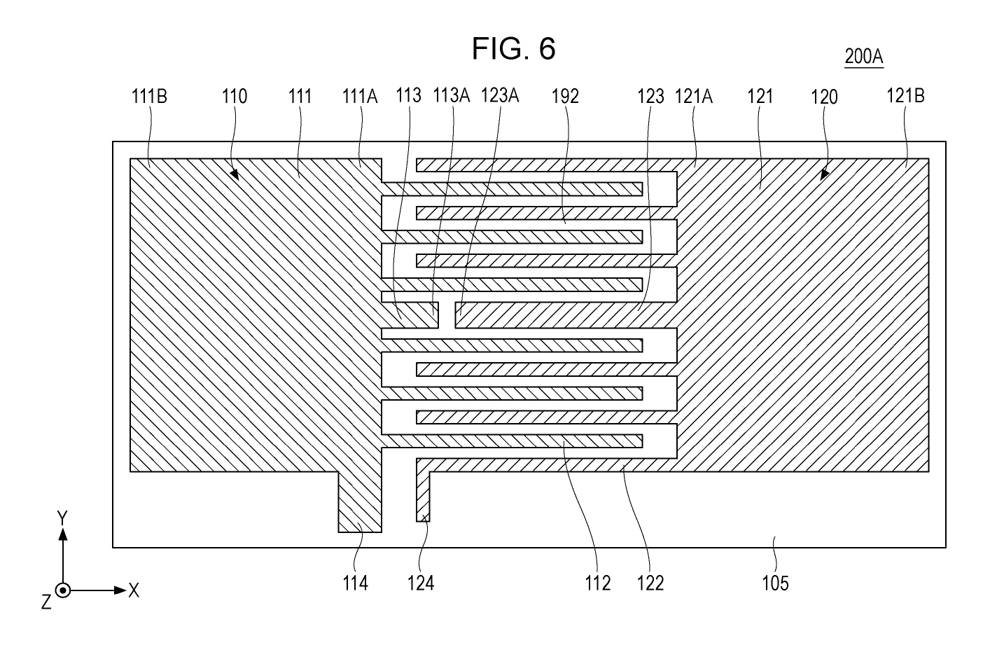

FIG. 2 illustrates a configuration in which the cover portion 180 is excluded from the wireless communication device 100 illustrated in FIG. 1. FIG. 3 illustrates a configuration in which the IC chip 130, the coil 140L, the capacitance 140C, the matching circuit 150, the communication portion 160, the battery 170, and the cover portion 180 are excluded from the wireless communication device 100 illustrated in FIG. 1. FIG. 4A and FIG. 4B illustrate the base portion 101, the sheet portion 105, the antenna elements 110 and 120, the IC chip 130, the coil 140L, the capacitance 140C, the matching circuit 150, the communication portion 160, and the battery 170. FIG. 4A illustrates a configuration in which the cover portion 180 is excluded from the wireless communication device 100, and FIG. 4B is a cross sectional view taken along an arrow line IVB-IVB of FIG. 4A. FIG. 5 illustrates an inlay 200. FIG. 6 illustrates an element 200A in which the IC chip 130, the coil 140L, the capacitance 140C, the matching circuit 150, the communication portion 160, and the battery 170 are excluded from the inlay 200 illustrated in FIG. 5. The element 200A may be treated as an antenna device.

The inlay 200 is constituted by the sheet portion 105, the antenna elements 110 and 120, the IC chip 130, the coil 140L, the capacitance 140C, the matching circuit 150, the communication portion 160, and the battery 170.

Hereinafter, an entire configuration of the wireless communication device 100 will be illustrated with reference to FIG. 1 to FIG. 3. FIG. 1 to FIG. 3 are transparently illustrated to easily comprehend an internal configuration. Detailed configurations of the antenna elements 110 and 120, the IC chip 130, the coil 140L, the capacitance 140C, the matching circuit 150, the communication portion 160, the battery 170, the inlay 200, and the like will be described with reference to FIG. 4A, FIG. 4B, FIG. 5, and FIG. 6.

A surface where the IC chip 130, the coil 140L, the capacitance 140C, the matching circuit 150, the communication portion 160, and the battery 170 of the thin-plate like wireless communication device 100 are mounted will be referred to as a top surface, and a surface on an opposite side to the top surface will be referred to as a bottom surface.

The wireless communication device 100 is a hybrid-type tag having communication functions based on two different standards. The wireless communication device 100 is a tag having both a function as a radio frequency identifier (RFID) tag and a function as a Bluetooth Low Energy (BLE) (registered trademark) communication device. The function as the RFID tag of the wireless communication device 100 is a function as a passive-type RFID tag including no power source. The wireless communication device 100 performs a communication at 920 MHz as the RFID tag, for example.

The wireless communication device 100 performs a communication at 2.45 GHz as the BLE communication device, for example. A mode in which the wireless communication device 100 has the function as the BLE communication device will be described, for example, but the wireless communication device 100 may have the function as the communication device for performing the communication based on Wifi or low power wide area (LPWA) instead of BLE.

The wireless communication device 100 may perform the communications based on the two different standards while both the IC chip 130 and the communication portion 160 use a single loop antenna 190 constituted by the antenna elements 110 and 120.

The base portion 101 is a thin plate like (rectangular parallelepiped shape) member as illustrated in FIG. 1, FIG. 2, FIG. 3, FIG. 4A, and FIG. 4B. It is sufficient when the base portion 101 is made of a dielectric. For example, the base portion 101 may be manufactured by using ABS resin, polyethylene terephthalate (PET) resin, polycarbonate resin, polyvinyl chloride (PVC) resin, or the like.

As illustrated in FIG. 1, the inlay 200 (see FIG. 5) is wound around the base portion 101 in an X-axis direction. With regard to the base portion 101, a length in the X-axis direction is approximately 35 mm, a width in a Y-axis direction is approximately 25 mm, and a thickness in a Z-axis direction is approximately 1.2 mm. Both ends in the X-axis direction of the base portion 101 will be referred to as end portions 101A and 101B.

As illustrated in FIG. 5, the sheet portion 105 is a rectangular film in a plan view, and the antenna elements 110 and 120 are formed on one surface. The sheet portion 105 is an example of a sheet member. The sheet portion 105 is a PET film or a film-like member made of PET resin or paper, for example.

The antenna elements 110 and 120 are formed on one surface of the sheet portion 105. In a state in which the IC chip 130, the coil 140L, the capacitance 140C, the matching circuit 150, the communication portion 160, and the battery 170 are mounted, the sheet portion 105 is bonded to the base portion 101 while being wound. That is, for example, in a state in which the inlay 200 (see FIG. 6) is completed and the IC chip 130, the coil 140L, the capacitance 140C, the matching circuit 150, the communication portion 160, and the battery 170 are mounted, the sheet portion 105 is bonded while being wound around the base portion 101. The coil 140L, the capacitance 140C, the matching circuit 150, the communication portion 160, and the battery 170 may also be bonded after the sheet portion 105 is wound around the base portion 101.

As illustrated in FIG. 5 and FIG. 6, the antenna element 110 is formed in an area corresponding to approximately a half of one surface of the sheet portion 105 in a longitudinal direction (X-axis direction). The antenna element 110 is an example of a first antenna element.

The antenna element 110 includes an element 111, a protrusion portion 112, a wiring portion 113, and a protrusion portion 114. The antenna element 110 and the antenna element 120 constitute the loop antenna 190. The loop antenna 190 is arranged so as to be wound around the base portion 101 in the X-axis direction. With regard to the loop antenna 190, a length in the X-axis direction is approximately 35 mm, a width in the Y-axis direction is approximately 23 mm, and a height in the Z-axis direction is approximately 1.2 mm.

It is sufficient when the antenna element 110 is made of a metal, and aluminum, copper, or the like may be used. The antenna element 110 may be manufactured by wet etching processing together with the antenna element 120, for example. When a metallic foil such as a copper foil is arranged on one of the surfaces of the sheet portion 105 and the wet etching processing is performed, patterning of the antenna elements 110 and 120 may be performed.

A mask used when resist formed on the metallic foil is exposed with light by photolithography before the wet etching processing is performed have openings in accordance with shapes of the antenna elements 110 and 120.

The element 111 is a rectangular radiant portion in a plan view. The protrusion portion 112 and the wiring portion 113 are connected to an end portion 111A on an X-axis positive direction side. The protrusion portion 114 is connected to an end of the end portion 111A on a Y-axis negative direction side. An end portion 111B is arranged on an opposite side to the end portion 111A. The element 111 is an example of a first base portion.

The element 111 is arranged from the end portion 111A located on a top surface side of the base portion 101 to the end portion 111B located on a bottom surface side of the base portion 101 and bent at the end portion 101A of the base portion 101.

As illustrated in FIG. 4B, the end portion 111B is overlapped with an end portion 121B of an element 121 which will be described below on the bottom surface side of the base portion 101 in a state in which the inlay 200 is wound around the base portion 101.

A portion where the end portion 111B and the end portion 121B are overlapped with each other in a plan view constitutes an overlapped portion 191. In the overlapped portion 191, the end portion 111B and the end portion 121B are insulated by the sheet portion 105.

As illustrated in FIG. 4A, FIG. 4B, FIG. 5, and FIG. 6, the protrusion portion 112 extends from the end portion 111A of the element 111 so as to protrude in an X-axis positive direction. Three protrusion portions 112 are arranged on a Y-axis positive direction side with respect to the wiring portion 113, and three protrusion portions 112 are arranged on the Y-axis negative direction side with respect to the wiring portion 113. Lengths in the X-axis direction of the six protrusion portions 112 are all equal to one another. The protrusion portion 112 is an example of a first protrusion portion. Since FIG. 1 to FIG. 3 are illustrated based on a simulation model which will be described below, 12 protrusion portions 112 are arranged.

Widths of the six protrusion portions 112 (widths in the Y-axis direction) are equal to one another and respectively have uniform widths (widths in the Y-axis direction) from a side to be connected to the element 111 to a tip on the X-axis positive direction side. The protrusion portion 112 and the protrusion portion 122 of the antenna element 120 are arranged in a nested manner in a plan view.

The protrusion portion 112, the wiring portion 113, the protrusion portion 122, and the wiring portion 123 constitute an interdigital portion 192. The interdigital portion 192 functions as a capacitor having a predetermined electrostatic capacitance. The interdigital portion 192 may be treated as a capacitor connected in parallel to the loop antenna 190 constituted by the antenna elements 110 and 120.

Respective dimensions such as lengths in the X-axis direction, widths in the Y-axis direction, heights in the Z-axis direction, intervals in the X-axis direction, and intervals in the Y-axis direction of the protrusion portion 112, the wiring portion 113, the protrusion portion 122, the wiring portion 123 may be set as appropriate values so as to set the electrostatic capacitance of the interdigital portion 192 as a desired value.

The wiring portion 113 extends from the end portion 111A of the element 111 so as to protrude in the X-axis positive direction. The wiring portion 113 is an example of a first wiring portion. The width of the wiring portion 113 (width in the Y-axis direction) is uniform from the side connected to the element 111 to the tip on the X-axis positive direction side. The width of the wiring portion 113 is approximately twice as wide as the width of the protrusion portion 112, for example.

Since a current flows through the wiring portion 113 at the time of the communication of the wireless communication device 100, the width of the wiring portion 113 is preferably set to be thick so as to decrease a resistance value of the wiring portion 113. For this reason, the width of the wiring portion 113 is set to be thicker than the protrusion portion 112 in the wireless communication device 100 according to the embodiment. The width of the wiring portion 113 is equal to the width of the wiring portion 123 connected via the IC chip 130.

The wiring portion 113 is located between the three protrusion portions 112 and the three protrusion portions 112. The wiring portion 113 includes a terminal 113A on the tip, and the IC chip 130 is connected to the terminal 113A. The wiring portion 113 is arranged on a central axis in parallel with an X axis of the antenna element 120, for example. The terminal 113A is an example of a first terminal.

In a state before the IC chip 130 is connected, as illustrated in FIG. 6, the wiring portion 113 is formed while a gap in the X-axis direction is prepared with a terminal 123A on a tip of the wiring portion 123. One of two terminals of the IC chip 130 is connected to the terminal 113A by soldering or the like. As an example, a mode in which the wiring portion 113 is set to be shorter than the wiring portion 123, and the IC chip 130 is offset on an X-axis negative direction side in a plan view of FIG. 4A and FIG. 4B will be described, but the wiring portion 113 may be longer than the wiring portion 123, or the lengths may be equal to each other. A position in the X-axis direction of the IC chip 130 is determined in accordance with the lengths of the wiring portion 113 and the wiring portion 123.

The protrusion portion 114 is connected to the end on the Y-axis negative direction side of the end portion 111A. The protrusion portion 114 exists only on the top surface of the wireless communication device 100 and does not exist on a side surface (lateral face on the X-axis negative direction side) and the bottom surface of the wireless communication device 100 in a state in which the sheet portion 105 is wound around the base portion 101.

The protrusion portion 114 is a portion arranged for the connection of the coil 140L, the capacitance 140C, the matching circuit 150, and the communication portion 160. One end of the coil 140L, one end of the capacitance 140C, one end of the capacitance 150C of the matching circuit 150, and a terminal 160A of the communication portion 160 are connected to the protrusion portion 114.

The portion in the protrusion portion 114 where the one end of the coil 140L, the one end of the capacitance 140C, the one end of the capacitance 150C of the matching circuit 150, and the terminal 160A of the communication portion 160 are connected (portion corresponding to the end on the X-axis positive direction side of the protrusion portion 114 and extending in the Y-axis direction) is an example of a second terminal.

As illustrated in FIG. 5 and FIG. 6, the antenna element 120 is formed in an area corresponding to approximately a half of one surface of the sheet portion 105 in a longitudinal direction. The antenna element 120 is an example of a second antenna element.

The antenna element 120 includes the element 121, a protrusion portion 122, a wiring portion 123, and a protrusion portion 124. The antenna element 120 constitutes the loop antenna 190 together with the antenna element 110.

It is sufficient when the antenna element 120 is made of a metal, and aluminum, copper, or the like may be used. The antenna element 120 may be manufactured by the wet etching processing together with the antenna element 110, for example. When the metallic foil such as the copper foil is arranged on one of the surfaces of the sheet portion 105 and the wet etching processing is performed, the patterning of the antenna elements 110 and 120 may be performed.

The element 121 is a rectangular radiant portion in a plan view. The protrusion portion 122 and the wiring portion 123 are connected to an end portion 121A on the X-axis negative direction side, and the end portion 121B is arranged on an opposite side to the end portion 121A. The element 121 is an example of a second base portion.

The element 121 is arranged from the end portion 121A located on the top surface side of the base portion 101 to the end portion 121B located on the bottom surface side of the base portion 101 and bent on an end portion 101B side of the base portion 101.

The element 121 is overlapped with the element 111 in the end portion 121B.

As illustrated in FIG. 4B, the end portion 121B is overlapped with the end portion 111B of the element 111 on the bottom surface side of the base portion 101 in a state in which the inlay 200 is wound around the base portion 101.

A portion where the end portion 121B and the end portion 111B are overlapped with each other in a plan view constitutes the overlapped portion 191, and the end portion 121B and the end portion 111B are insulated by the sheet portion 105 in the overlapped portion 191.

As illustrated in FIG. 4A, FIG. 4B, FIG. 5, and FIG. 6, the protrusion portion 122 extends so as to protrude from the end portion 121A of the element 121 in the X-axis negative direction. Three protrusion portions 122 are arranged on the Y-axis positive direction side with respect to the wiring portion 123, and three protrusion portions 122 are arranged on the Y-axis negative direction side with respect to the wiring portion 123. All lengths in the X-axis direction of the six protrusion portions 122 are equal to one another. The protrusion portion 122 is an example of a second protrusion portion. Since FIG. 1 to FIG. 3 are illustrated based on the simulation model which will be described below, 12 protrusion portions 122 are arranged.

Widths of the six protrusion portions 122 (widths in the Y-axis direction) are equal to one another and respectively have uniform widths (widths in the Y-axis direction) from a side to be connected to the element 121 to a tip on the X-axis positive direction side. The width of the protrusion portion 122 is equal to the width of the protrusion portion 112. The six protrusion portions 122 and the six protrusion portions 112 are arranged in a nested manner in a plan view.

The wiring portion 123 extends from the end portion 121A of the element 121 so as to protrude in the X-axis negative direction. The wiring portion 123 is an example of a second wiring portion.

The width of the wiring portion 123 (width in the Y-axis direction) is uniform from the side to be connected to the element 121 to the tip on the X-axis negative direction side. The width of the wiring portion 123 is equal to the width of the wiring portion 113 and is approximately twice as wide as the width of the protrusion portion 122.

Since a current flows through the wiring portion 123 at the time of the communication of the wireless communication device 100, the width of the wiring portion 123 is preferably set to be thicker so as to decrease a resistance value of the wiring portion 123. For this reason, the width of the wiring portion 123 is set to be thicker than the protrusion portion 122 in the wireless communication device 100 according to the embodiment.

The wiring portion 123 is located between the three protrusion portions 122 on the Y-axis positive direction side and the three protrusion portions 122 on the Y-axis negative direction side. The terminal 123A is arranged on the tip of the wiring portion 123. The IC chip 130 is connected to the terminal 123A as illustrated in FIG. 1. The wiring portion 123 is arranged on a central axis in parallel with the X axis of the antenna element 120, for example. The terminal 123A is an example of a third terminal.

In a state before the IC chip 130 is connected, as illustrated in FIG. 6, the wiring portion 123 is formed while a gap in the X-axis direction is prepared with the terminal 113A on the tip of the wiring portion 113. The other one of the two terminals of the IC chip 130 is connected to the terminal 123A by soldering or the like.

The above-mentioned wiring portion 123 constitutes the interdigital portion 192 together with the protrusion portion 122, the protrusion portion 112, and the wiring portion 113.

The protrusion portion 124 is a portion connected to the tip of the protrusion portion 122 arranged at a farthest end on the negative side in the Y-axis direction and formed so as to bend from the tip of the protrusion portion 122 in the Y-axis negative direction. The other end of the coil 140L, the other end of the capacitance 140C, the other end of the capacitance 150C of the matching circuit 150, and one end of the coil 150L of the matching circuit 150 are connected to the protrusion portion 124.

A portion where the other end of the coil 140L, the other end of the capacitance 140C, the other end of the capacitance 150C of the matching circuit 150, and one end of the coil 150L of the matching circuit 150 in the protrusion portion 124 is an example of a fourth terminal.

With regard to the loop antenna 190 constituted by the antenna elements 110 and 120, the dimensions of the respective portions, inductances, the electrostatic capacitances, and the like are appropriately set such that a resonance frequency becomes 920 MHz. That is, for example, the loop antenna 190 is appropriately set in accordance with the state in which the wireless communication device 100 functions as the RFID tag.

A loop length of the loop antenna 190 (length of a loop from the terminal 113A via the overlapped portion 191 to the terminal 123A) is shorter than one wavelength at 920 MHz, and the loop antenna 190 is an antenna functioning as an inductor. The loop antenna 190 has a configuration in which the loop antenna 190 resonates at 920 MHz by the electrostatic capacitance of the interdigital portion 192, the overlapped portion 191, and the like.

The inductance of the loop antenna 190 is an example of the first inductance. 920 MHz corresponding to the resonance frequency at which the wireless communication device 100 functions as the RFID tag is an example of a first frequency.

The IC chip 130 is an IC chip for the RFID tag. The IC chip 130 includes two terminals 131 and 132 to be mounted onto the surface of the sheet portion 105. The two terminals 131 and 132 of the IC chip 130 are respectively connected to the terminals 113A and 123A by soldering or the like. The IC chip 130 is electrically connected to the antenna elements 110 and 120 and stores data representing a unique identifier (ID) in an internal memory chip.

When a signal for reading a radio frequency (RF) band is received from a reader writer of the wireless communication device 100 via the antenna elements 110 and 120, the IC chip 130 operates by power of the received signal and transmits the data representing the ID via the antenna elements 110 and 120. As a result, the reader writer may read the ID of the wireless communication device 100.

The IC chip 130 is an example of a first communication circuit. The impedance of the IC chip 130 is approximately 1700Ω to approximately 3800Ω and is an example of a first impedance.

The coil 140L has two terminals, and the two terminals are connected to the protrusion portion 114 and the protrusion portion 124. That is, for example, the coil 140L is inserted between the protrusion portion 114 and the protrusion portion 124 in series. The coil 140L is arranged on the surface of the sheet portion 105.

The coil 140L has an inductance sufficiently higher than the inductance of the loop antenna 190. As an example, the inductance of the coil 140L is preferably set to be higher than the inductance of the loop antenna 190 by approximately two orders of magnitude. For example, the inductance of the coil 140L is preferably set to be 100 times as high as the inductance of the loop antenna 190.

The coil 140L is arranged to behave such that high frequency power at 920 MHz is interrupted, and the protrusion portion 114 and the protrusion portion 124 are disconnected (open) with respect to the power at 920 MHz when the wireless communication device 100 functions as the RFID tag and the loop antenna 190 receives the power at 920 MHz. The inductance of the coil 140L is an example of a second inductance.

The capacitance 140C and the capacitance 150C are connected to the coil 140L in parallel. An equivalent state is established in which, while the inductance of the coil 140L is set as a sufficiently high value, the protrusion portion 114 and the protrusion portion 124 are open when a current at 920 MHz flows through the loop antenna 190.

The matching circuit 150 is connected to the protrusion portion 114 and the protrusion portion 124 to connect the communication portion 160. Since the matching circuit 150 is not used when the wireless communication device 100 functions as the RFID tag, the coil 140L having the above-mentioned inductance is connected between the protrusion portion 114 and the protrusion portion 124 in series such that the matching circuit 150 is not visible from the terminals 113A and 123A.

The state in which the inductance of the coil 140L is sufficiently higher than the inductance of the loop antenna 190 means that the inductance is high to such an extent that the equivalent state may be realized in which the protrusion portion 114 and the protrusion portion 124 are open when the current at 920 MHz flows through the loop antenna 190 as described above.

The capacitance 140C has two terminals, and the two terminals are connected to the protrusion portion 114 and the protrusion portion 124. The capacitance 140C is connected to the coil 140L in parallel. The capacitance 140C is arranged on the surface of the sheet portion 105.

The capacitance 140C has an electrostatic capacitance having a complex conjugate relationship with the inductance of the coil 140L. A reason why the electrostatic capacitance of the capacitance 140C is set as the above-mentioned value is that an imaginary component of the impedance of the coil 140L is to be cancelled.

The capacitance 140C is arranged such that the coil 140L is not visible when the matching circuit 150 side is viewed from the two terminals of the matching circuit 150 to be connected to two terminals 160A and 160B of the communication portion 160. The state in which the coil 140L is not visible from the two terminals of the matching circuit 150 means that the impedance in which the matching circuit 150 side is viewed from the two terminals of the matching circuit 150 does not include the impedance of the coil 140L. In other words, for example, the state in which the coil 140L is not visible from the two terminals of the matching circuit 150 is equivalent to a state in which the coil 140L does not exist.

The capacitance 140C is connected to the coil 140L in parallel such that the coil 140L becomes invisible from the two terminals of the matching circuit 150. The capacitance 140C has an electrostatic capacitance having a complex conjugate relationship with the inductance of the coil 140L.

The matching circuit 150 includes the coil 150L and the capacitance 150C and is arranged on the surface of the sheet portion 105. The coil 150L has two terminals, and the two terminals are respectively connected to the protrusion portion 124 and the terminal 160B of the communication portion 160. The capacitance 150C has two terminals, and the two terminals are connected to the protrusion portion 114 and the protrusion portion 124. That is, for example, the coil 150L is connected to the communication portion 160 in series, and the capacitance 150C is connected to the communication portion 160 in parallel.

The impedance of the IC chip 130 for the RFID tag is approximately 1700Ω to approximately 3800Ω. In contrast, the impedance of the communication portion 160 for BLE is 50Ω. In this manner, the impedances of the IC chip 130 and the communication portion 160 largely vary.

The matching circuit 150 is arranged such that both the IC chip 130 and the communication portion 160 described above use the single loop antenna 190. The impedance of the circuit including the matching circuit 150, the loop antenna 190, the IC chip 130, the coil 140L, and the capacitance 140C appears to have 50Ω when viewed from the communication portion 160.

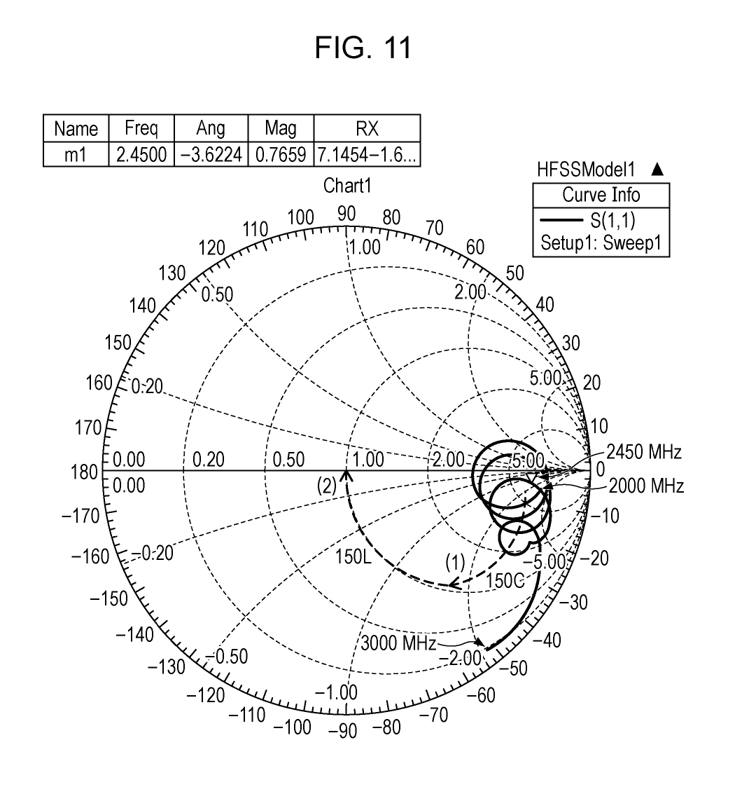

Details with regard to an inductance of the coil 150L and an electrostatic capacitance of the capacitance 150C will be described below with reference to a Smith chart of FIG. 11.

The communication portion 160 is a communication portion that performs a communication based on BLE and is arranged on the surface of the sheet portion 105. More specifically, for example, the communication portion 160 is a communication module that regularly outputs a BLE beacon having a unique identifier (ID). The communication portion 160 performs the communication in a frequency band at 2.45 GHz.

The communication portion 160 includes two terminals 160A and 160B connected to the loop antenna 190. The terminal 160A is connected to the protrusion portion 114, and the terminal 160B is connected to one end of the coil 150L. The communication portion 160 is driven by power supplied from the battery 170 via a power supply line 170A. When the communication portion 160 outputs the beacon, the beacon is radiated from the loop antenna 190.

The impedance of the communication portion 160 is 50Ω, for example. That is, for example, the impedance of the communication portion 160 is much lower than the impedance of the IC chip 130 (approximately 1700Ω to approximately 3800Ω). The communication portion 160 is an example of a second communication circuit. The impedance of the communication portion 160 is an example of a second impedance. 2.45 GHz corresponding to the frequency band at which the communication portion 160 performs the communication is an example of a second frequency.

The battery 170 is arranged on the surface of the sheet portion 105 and connected to the communication portion 160 via the power supply line 170A. The battery 170 supplies the power to the communication portion 160 via the power supply line 170A. The battery 170 is realized by a button-type battery cell or the like.

The overlapped portion 191 is a portion where the end portion 111B of the antenna element 110 and the end portion 121B of the antenna element 120 are overlapped with each other. Since the high frequency current at 920 MHz flows through the antenna elements 110 and 120, the overlapped portion 191 is connected in an alternating current manner, and the antenna elements 110 and 120 constitute the loop antenna 190.

The overlapped portion 191 may be used to adjust the resonance frequency of the wireless communication device 100. The electrostatic capacitance of the overlapped portion 191 is determined by an overlapped area between the end portions 111B and 121B and an interval between the end portions 111B and 121B.

The overlapped portion 191 includes a portion overlapped with the interdigital portion 192. In this manner, when the overlapped portion 191 and the interdigital portion 192 are overlapped with each other in the Z-axis direction, the electrostatic capacitance may also be secured between the overlapped portion 191 and the interdigital portion 192. When the resonance frequency of the wireless communication device 100 may also be adjusted by adjusting the above-mentioned electrostatic capacitance related to the overlapped portion 191.

The interdigital portion 192 is constituted by the protrusion portion 112, the wiring portion 113, the protrusion portion 122, and the wiring portion 123 arranged in a nested manner in parallel in a plan view.

The interdigital portion 192 is arranged to adjust the resonance frequency of the loop antenna 190 of the wireless communication device 100 by earning the electrostatic capacitance generated when the protrusion portion 112, the wiring portion 113, the protrusion portion 122, and the wiring portion 123 are arranged so as to be adjacent to one another. The interdigital portion 192 is formed across the antenna elements 110 and 120.

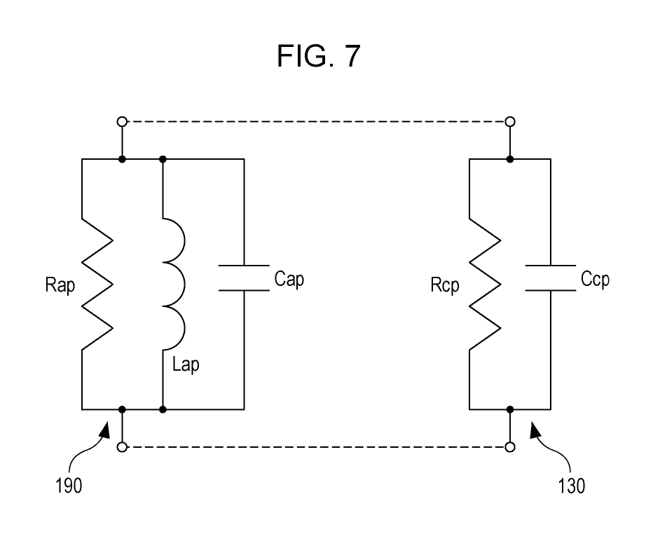

FIG. 7 illustrates an equivalent circuit of the wireless communication device 100 as the RFID tag. The loop antenna 190 constituted by the antenna elements 110 and 120 may be represented by a resistor Rap and an inductor Lap. Since the overlapped portion 191 and the interdigital portion 192 are arranged in the loop antenna 190 in the wireless communication device 100 according to the embodiment, in FIG. 7, a capacitor Cap is connected to the resistor Rap and the inductor Lap in parallel. The capacitor Cap is represented as a single capacitor while the overlapped portion 191 and the interdigital portion 192 are combined with each other.

The IC chip 130 of the wireless communication device 100 may be represented by a resistor Rcp and a capacitor Ccp.

That is, for example, the loop antenna 190 includes a resistance component and an inductance component, and also a capacitance component is connected to the loop antenna 190. The IC chip 130 may be represented as the resistance component and the capacitance component.

The resistor Rap is a resistor having a resistance value Rap. The inductor Lap is an inductor in which an inductance is Lap. The capacitor Cap is a capacitor in which a capacitance is Cap. The resistor Rcp is a resistor having a resistance value Rcp. The capacitor Ccp is a capacitor in which a capacitance is Ccp.

For example, Rcp is 2000Ω, and Ccp is approximately 1.0 pF. These are average values obtained in a general-use IC chip.

The wireless communication device 100 performs the communication while the equivalent circuit illustrated in FIG. 7 is caused to generate resonance. That is, for example, when the wireless communication device 100 receives the signal for reading and transmits the data representing the ID, a current based on the resonance flows through the IC chip 130 and the antenna elements 110 and 120.

A resonance frequency of a resonance current is mainly determined by the electrostatic capacitance of the IC chip 130, the inductances of the antenna elements 110 and 120, the electrostatic capacitance of the overlapped portion 191, and the electrostatic capacitance of the interdigital portion 192.

The resonance frequency of the wireless communication device 100 is obtained by Expression (1).

$${f}_{0} = \frac{1}{2 π \sqrt{Lap ( Ccp + Cap )}} \qquad ( 1 )$$

In Expression (1), Lap denotes the inductances Lap of the antenna elements 110 and 120, Ccp denotes the capacitance Ccp of the IC chip 130, and Cap denotes the capacitance Cap of the overlapped portion 191 and the interdigital portion 192.

In this manner, the resonance frequency of the wireless communication device 100 is determined by not only the loop antenna 190 (the antenna elements 110 and 120) but also the loop antenna 190 (the antenna elements 110 and 120), the overlapped portion 191, the interdigital portion 192, and the IC chip 130.

In this aspect, the loop antenna 190 included in the wireless communication device 100 is different from a so-called loop antenna that generates resonance by setting the loop length as a length of one wavelength at the resonance frequency.

The resonance frequency of the resonance current in the wireless communication device 100 according to the embodiment is a frequency (communication frequency) at which the wireless communication device 100 performs the communication and is set as 920 MHz, for example. The loop length of the loop antenna 190 constituted by the antenna elements 110 and 120 is approximately 70 mm and is set to be shorter than the wavelength at the resonance frequency.

As an example, in a case where the resonance frequency is 920 MHz, the wavelength at the resonance frequency is approximately 325 mm, and the loop length of the loop antenna 190 in the wireless communication device 100 is approximately 70 mm.

In this manner, since the loop length of the loop antenna 190 is shorter than the length of the one wavelength at the resonance frequency, unlike the so-called loop antenna that sets the loop length as the one wavelength at the resonance frequency, the antenna elements 110 and 120 constituting the loop antenna 190 function as the inductors.

The length (loop length) corresponding to the combination of the antenna elements 110 and 120 is relatively short as described above, and the inductances of the antenna elements 110 and 120 are in proportion to the length. Therefore, the inductance of the loop antenna 190 is relatively low. In the wireless communication device 100, to compensate the low inductance, the resonance frequency is adjusted by arranging the overlapped portion 191 and the interdigital portion 192 in the loop antenna 190.

The impedance of the antenna obtained by adding the overlapped portion 191 and the interdigital portion 192 to the loop antenna 190 constituted by the antenna elements 110 and 120 is determined by the resistance value (Rap) of the resistor Rap, the inductance (Lap) of the inductor Lap, and the capacitance (Cap) of the capacitor Cap illustrated in FIG. 7.

The impedance of the IC chip 130 is determined by the resistance value (Rcp) of the resistor Rcp and the capacitance (Ccp) of the capacitor Ccp.

To obtain satisfactory impedance matching between the loop antenna 190 and the IC chip 130, the resistance value Rap and the resistance value Rcp may be adjusted in addition to the adjustment of the inductance Lap, the capacitance Cap, and the capacitance Ccp.

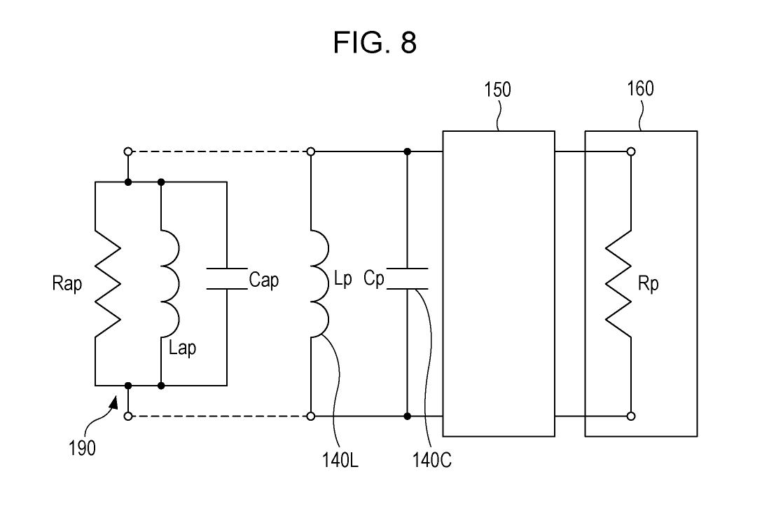

FIG. 8 illustrates an equivalent circuit of the wireless communication device 100 as the BLE communication device. Similarly as in FIG. 7, the loop antenna 190 is represented by the resistor Rap and the inductor Lap, and the capacitor Cap is connected to the loop antenna 190 in parallel.

An inductor Lp representing the coil 140L, a capacitor Cp representing the capacitance 140C, and the matching circuit 150 are connected to the resistor Rap, the inductor Lap, and the capacitor Cap in parallel, and the communication portion 160 is connected to the matching circuit 150. The communication portion 160 may be represented by a resistor Rp. The resistor Rp is 50Ω.

Since the impedance appears to have 50Ω when viewed from the matching circuit 150 side from the two terminals of the matching circuit 150 to which the terminals 160A and 160B of the communication portion 160 are connected, the communication portion 160 may perform the communication based on BLE via the loop antenna 190.

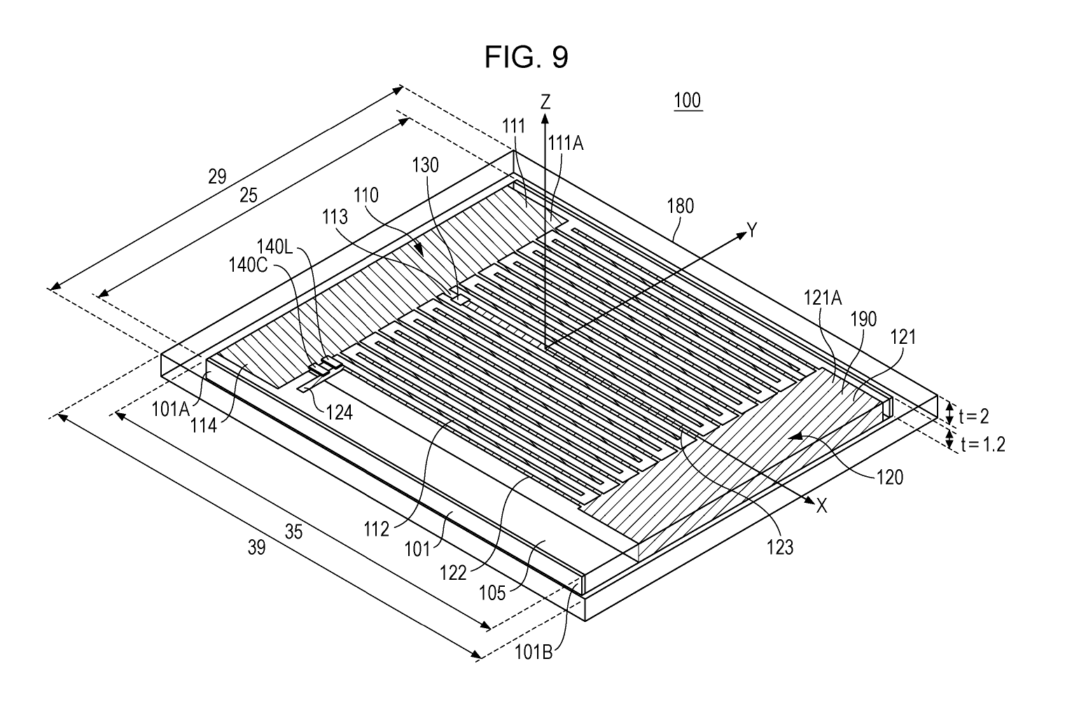

FIG. 9 illustrates the simulation model of the wireless communication device 100. According to the simulation model of the wireless communication device 100, the length in the X-axis direction of the loop antenna 190 is approximately 35 mm, the width in the Y-axis direction is approximately 23 mm, and the height in the Z-axis direction is approximately 1.2 mm.

The simulation model of the wireless communication device 100 does not include the matching circuit 150, the communication portion 160, and the battery 170.

The 12 protrusion portions 112 and the 12 protrusion portions 122 are arranged in the interdigital portion 192. The widths of the protrusion portions 112 and 122 are 0.2 mm, and the intervals between the protrusion portion 112, the wiring portion 113, and the protrusion portion 122 in the Y-axis direction are set as 0.62 mm.

The cover portion 180 is made of fire resistant resin. A relative permittivity of the fire resistant resin is 3.2. A dielectric tangent tan δ is 0.02. A length in the X-axis direction is approximately 39 mm. A width in the Y-axis direction is approximately 29 mm. A thickness in the Z-axis direction is approximately 2 mm.

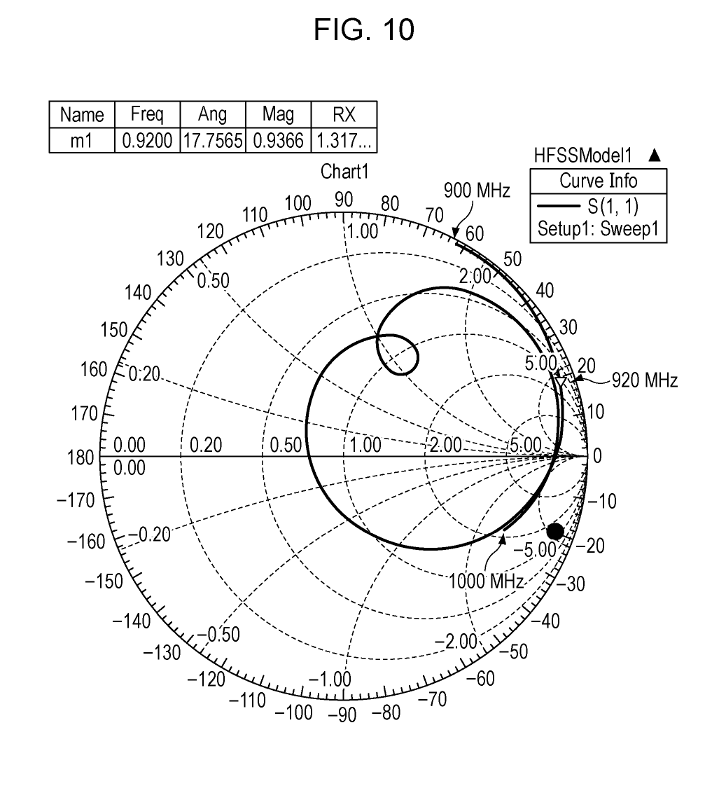

FIG. 10 is a Smith chart illustrating an impedance characteristic in a case where the wireless communication device 100 functions as the RFID tag. The impedance illustrated in FIG. 10 is the impedance of the wireless communication device 100 as the loop antenna 190 side is viewed from the terminals 113A and 123A from to which the IC chip 130 is connected. A black circle in FIG. 10 indicates the impedance of the IC chip 130.

When the communication frequency is changed from 900 MHz to 1000 MHz, a trajectory drawing a circle is obtained, and the impedance having the complex conjugate relationship with the impedance of the IC chip 130 indicated by the black circle is obtained as the impedance 920 MHz indicated by a triangular marker.

That is, for example, matching between the impedance of the wireless communication device 100 and the impedance of the IC chip 130 as the loop antenna 190 side is viewed from the terminals 113A and 123A may be confirmed.

In this manner, when the impedance of the loop antenna 190 is adjusted to have the impedance having the complex conjugate relationship with the impedance of the IC chip 130, the loop antenna 190 and the IC chip 130 resonate at 920 MHz, and the power received by the loop antenna 190 is supplied to the IC chip 130.

FIG. 11 is a Smith chart illustrating the impedance characteristic in a case where the wireless communication device 100 functions as the BLE communication device. The impedance illustrated in FIG. 10 is the impedance of the wireless communication device 100 as the loop antenna 190 side is viewed from the protrusion portions 114 and 124 to which the matching circuit 150 is connected.

When the communication frequency is changed from 2000 MHz to 3000 MHz, the impedance at 2450 MHz is obtained at a position indicated by a triangular marker. The above-mentioned impedance may be set as 50Ω by setting the electrostatic capacitance of the capacitance 150C of the matching circuit 150 and the inductor of the coil 150L as follows.

First, the impedance indicated by the triangular marker is moved to a position indicated by an arrow (1) by appropriately selecting the electrostatic capacitance of the capacitance 150C connected to the communication portion 160 in parallel.

The impedance is moved from the position indicated by the arrow (1) to a position indicated by an arrow (2) by appropriately selecting the inductor of the coil 150L connected to the communication portion 160 in series.

Since the position indicated by the arrow (2) is 50Ω, when the electrostatic capacitance of the capacitance 150C of the matching circuit 150 and the inductance of the coil 150L are appropriately selected, the impedance of the wireless communication device 100 as the loop antenna 190 side is viewed from the two terminals of the matching circuit 150 to which the terminals 160A and 160B of the communication portion 160 are connected may be set as 50Ω.

More specifically, for example, the two terminals of the matching circuit 150 to which the terminals 160A and 160B of the communication portion 160 are connected are the terminal on the Y-axis negative direction side of the coil 150L and the terminal on the X-axis negative direction side of the capacitance 150C (terminals connected to the protrusion portions 114). The terminal 160A of the communication portion 160 is connected to the terminal on the X-axis negative direction side of the capacitance 150C via the protrusion portion 114.

In this manner, since the impedance when the loop antenna 190 side is viewed from the two terminals of the matching circuit 150 to which the terminals 160A and 160B of the communication portion 160 are connected becomes 50Ω, the communication portion 160 may perform the communication based on BLE via the loop antenna 190.

As described above, according to the embodiment, the equivalent state is established in which the coil 140L having the inductance sufficiently higher than the loop antenna 190 is connected between the protrusion portions 114 and 124 of the loop antenna 190, and the portion between the protrusion portion 114 and the protrusion portion 124 is open.

For this reason, the loop antenna 190 resonates with the IC chip 130 at 920 MHz, and the wireless communication device 100 may function as the RFID tag.

The capacitance 140C having the electrostatic capacitance having the complex conjugate relationship with the inductance of the coil is connected to the coil 140L in parallel. The matching circuit 150 is also connected between the protrusion portion 114 and the protrusion portion 124 to connect the communication portion 160 via the matching circuit 150. The impedance when the matching circuit 150 side is viewed from the communication portion 160 is 50Ω.

For this reason, the beacon output by the communication portion 160 is radiated from the loop antenna 190.

Therefore, according to the embodiment, the wireless communication device and the antenna device may be provided which the plurality of communications having the largely varying impedances may be performed.

The wireless communication device 100 may be used as follows, for example. A body temperature and/or sweat rate of a personnel working in open air or the like may be transmitted as Internet of Things (IoT) sensor information to manage a physical condition of the working personnel at an access point in the communication area of the BLE system. At this time, the personnel may be identified by reading the ID included in the beacon in the communication area of the BLE system. When the personnel passes through a gate (entry and exit gate) outside the communication area of the BLE system, the wireless communication device 100 may function as the RFID tag to read the ID of the personnel and grasp entry and exit times at the gate and the position.

A battery cell or a battery is mounted in a short-range wireless system based on BLE, Wifi, or LPWA in many cases, the RFID tag does not use the battery cell. For example, in a case where the reader of the RFID tag is arranged in a communication area of the short-range wireless system, the ID of the personnel may be grasped even when the battery cell or the battery of the short-range wireless system runs out. That is, for example, the function as the RFID tag may be used as a backup function.

The mode in which the loop antenna 190 is realized by the two antenna elements 110 and 120 has been described above, but the loop antenna 190 may be a loop-like antenna. That is, for example, the end portion 111B of the antenna element 110 may be connected to the end portion 121B of the antenna element 120.

The mode in which the coil 150L of the matching circuit 150 is connected between the protrusion portion 124 and the terminal 160B of the communication portion 160 has been described above, but the coil 150L may be connected between the protrusion portion 114 and the terminal 160A. In this case, the terminals connected to the terminals 160A and 160B of the communication portion 160 of the matching circuit 150 are a terminal connected to the terminal 160A of the communication portion 160 of the coil 150L and a terminal connected to the terminal on the X-axis positive direction side of the capacitance 150C via the protrusion portion 124.

The mode in which the matching circuit 150 includes the coil 150L connected to the communication portion 160 in series and the capacitance 150C connected to the communication portion 160 in parallel has been described above. However, the matching circuit 150 may include a configuration including the coil 150L connected to the communication portion 160 in parallel and the capacitance 150C connected to the communication portion 160 in series.

In this case, the impedance at 920 MHz indicated by the triangular marker illustrated in FIG. 11 is moved in the anticlockwise direction opposite to the clockwise direction arrows (1) and (2) by the coil 150L connected to the communication portion 160 in parallel and the capacitance 150C connected to the communication portion 160 in series to be moved to the positive at 50Ω indicated by the arrow (2). The beacon output by the communication portion 160 may be radiated from the loop antenna 190 in this manner too.

The mode in which the protrusion portion 114 is connected to the element 111 of the antenna element 110, and the protrusion portion 124 is connected to the tip of the protrusion portion 122 of the antenna element 120 has been described above. However, the protrusion portion 114 may be connected to the tip of the protrusion portion 112, and the protrusion portion 124 may be connected to the element 121. In this case, a configuration may be adopted in which the coil 140L, the capacitance 140C, and the capacitance 150C are connected between the protrusion portion 114 connected to the tip of the protrusion portion 112 and the protrusion portion 124 connected to the element 121, and the coil 150L is connected to the protrusion portion 114.

The mode in which the wireless communication device 100 includes the matching circuit 150 has been described above. In a case where a distance for radiating the beacon output by the communication portion 160 from the loop antenna 190 may be short, it is also sufficient when the wireless communication device 100 does not include the matching circuit 150.

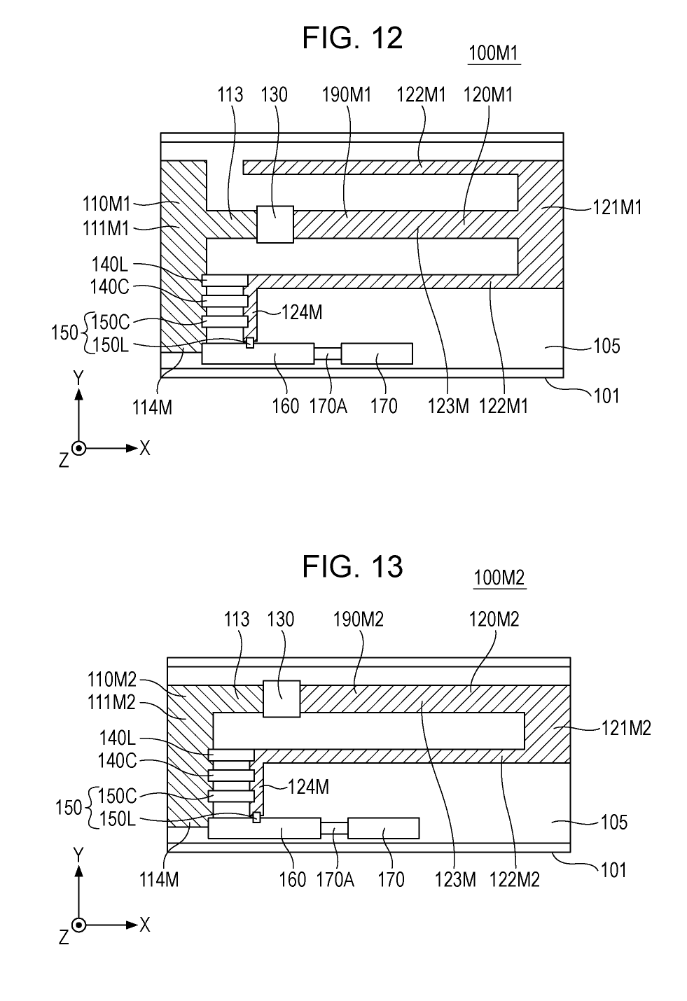

The wireless communication device 100 according to the embodiment may be modified as illustrated in FIG. 12 and FIG. 13. FIG. 12 illustrates a wireless communication device 100M1 according to a first modified example of the embodiment. In FIG. 12, components similar to the components illustrated in FIG. 1 to FIG. 6 are assigned with the same reference signs, and descriptions thereof will be omitted.

The wireless communication device 100M1 includes the base portion 101, the sheet portion 105, antenna elements 110M1 and 120M1, the IC chip 130, the coil 140L, the capacitance 140C, the matching circuit 150 (the coil 150L and the capacitance 150C), the communication portion 160, and the battery 170. The cover portion 180 is omitted in FIG. 12.

The antenna element 110M1 includes an element 111M1, the wiring portion 113, and a protrusion portion 114M. The antenna element 110M1 constitutes a loop antenna 190M1 together with the antenna element 120M1. The antenna element 110M1 does not include the protrusion portion 112 (see FIG. 1 to FIG. 6).

The element 111M1 is a stripe-like pattern extending in the Y-axis direction, the wiring portion 113 extends in the X-axis positive direction from an end on the Y-axis negative direction side of the element 111M1, and the protrusion portion 114M extends in the Y-axis negative direction. One end of the coil 140L, one end of the capacitance 140C, and one end of the capacitance 150C are connected to the protrusion portion 114M.

The antenna element 120M1 includes an element 121M1, a protrusion portion 122M1, a wiring portion 123M, and a protrusion portion 124M. The antenna element 120M1 constitutes the loop antenna 190M1 together with the antenna element 110M1. Two protrusion portions 122M1 are arranged, and the protrusion portion 124M is connected to a tip of the protrusion portion 122M1 located on the Y-axis negative direction side. A capacitance having predetermined electrostatic capacitance is constituted between the two protrusion portions 122M1 and the wiring portion 123M. This capacitance is used as a substitute of the interdigital portion 192. The other end of the coil 140L, the other end of the capacitance 140C, the other end of the capacitance 150C, and one end of the coil 150L are connected to the protrusion portion 124M.

As illustrated in FIG. 12, also in the wireless communication device 100M1 having the configuration in which the interdigital portion 192 (see FIG. 1 to FIG. 6) is not included, the loop antenna 190M1 resonates with the IC chip 130 at 920 MHz, and the wireless communication device 100 may function as the RFID tag. The beacon output by the communication portion 160 is radiated from the loop antenna 190M1.

Therefore, according to the first modified example of the embodiment, the wireless communication device 100M1 and the antenna device which the plurality of communications having the largely varying impedances may be performed may be provided.

FIG. 13 illustrates a wireless communication device 100M2 according to a second modified example of the embodiment. In FIG. 13, components similar to the components illustrated in FIG. 1 to FIG. 6 and FIG. 12 are assigned with the same reference signs, and descriptions thereof will be omitted.

The wireless communication device 100M2 includes the base portion 101, the sheet portion 105, antenna elements 110M2 and 120M2, the IC chip 130, the coil 140L, the capacitance 140C, the matching circuit 150 (the coil 150L and the capacitance 150C), the communication portion 160, and the battery 170. In FIG. 13, the cover portion 180 is omitted.

The antenna element 110M2 includes an element 111M2, the wiring portion 113, and a protrusion portion 114M. The antenna element 110M2 constitutes a loop antenna 190M2 together with an antenna element 120M2. The antenna element 110M2 does not include the protrusion portion 112 (see FIG. 1 to FIG. 6).

The element 111M2 is a rectangular pattern, and the wiring portion 113 extends in the X-axis positive direction from an end on the X-axis positive direction side of the element 111M2. The protrusion portion 114M extends in the Y-axis negative direction from an end on the Y-axis negative direction side of the element 111M2. One end of the coil 140L, one end of the capacitance 140C, and one end of the capacitance 150C are connected to the protrusion portion 114M.

The antenna element 120M2 includes an element 121M2, a protrusion portion 122M2, the wiring portion 123M, and the protrusion portion 124M. The antenna element 120M2 constitutes the loop antenna 190M2 together with the antenna element 110M2. One protrusion portion 122M2 is arranged, and the protrusion portion 124M is connected to a tip of the protrusion portion 122M2. A capacitance having the predetermined electrostatic capacitance is constituted between the protrusion portion 122M2 and the wiring portion 123M. This capacitance is used as a substitute of the interdigital portion 192. The other end of the coil 140L, the other end of the capacitance 140C, the other end of the capacitance 150C, and one end of the coil 150L are connected to the protrusion portion 124M.

As illustrated in FIG. 13, also in the wireless communication device 100M2 including the configuration in which the interdigital portion 192 (see FIG. 1 to FIG. 6) is not included, the loop antenna 190M2 resonates with the IC chip 130 at 920 MHz, and the wireless communication device 100 may function as the RFID tag. The beacon output by the communication portion 160 is radiated from the loop antenna 190M2.

Therefore, according to the second modified example of the embodiment, the wireless communication device 100M2 and the antenna device which the plurality of communications having the largely varying impedances may be performed may be provided.

The wireless communication device and the antenna device according to the illustrative embodiment have been described above, but the embodiment is not limited to the disclosed embodiment, and various modifications and alterations may be made without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communication device comprising:
a loop antenna that includes a first terminal and a second terminal, and a third terminal and a fourth terminal respectively corresponding to the first terminal and the second terminal, the loop antenna constituting a loop between the first terminal and the second terminal and the third terminal and the fourth terminal, and the loop antenna having a first inductance;
a first communication circuit that is coupled between the first terminal and the third terminal and has a first impedance, the first communication circuit resonating at a first frequency with the loop antenna;
a coil that is coupled between the second terminal and the fourth terminal and has a second inductance higher than the first inductance;
a capacitance that is coupled between the second terminal and the fourth terminal in parallel to the coil and has an electrostatic capacitance having a complex conjugate relationship with a second inductance of the coil; and
a second communication circuit that is coupled between the second terminal and the fourth terminal and has a second impedance lower than the first impedance, the second communication circuit performing a communication at a second frequency via the loop antenna.

2. The wireless communication device according to claim 1, further comprising:
a power source circuit that supplies power to the second communication circuit,
wherein the first communication circuit operates at the first frequency by power received by the loop antenna, and
wherein the second communication circuit operates by the power supplied from the power source circuit and performs the communication at the second frequency via the loop antenna.

3. The wireless communication device according to claim 1, further comprising:
a matching circuit that is arranged between the second terminal and the fourth terminal, and the fourth terminal and the second communication circuit, and perform matching of an impedance of the loop antenna in which the coil and the capacitance are coupled between the second terminal and the fourth terminal in series and an impedance of the second communication circuit.

4. The wireless communication device according to claim 3,
wherein the matching circuit includes one of:
a first circuit that includes a second capacitance coupled between the second terminal and the fourth terminal in series and coupled to the second communication circuit in parallel, and a second coil coupled between the second terminal or the fourth terminal and the second communication circuit in series, and
a second circuit that is includes a second capacitance coupled between the second terminal or the fourth terminal and the second communication circuit in series, and a second coil coupled between the second terminal and the fourth terminal in series and coupled to the second communication circuit in parallel.

5. The wireless communication device according to claim 1,
wherein the loop antenna includes a first antenna element and a second antenna element, the first antenna element and the second antenna element constituting the loop,
wherein the first antenna element includes:
a first base portion included in a part of the loop,
a first wiring portion protruding from the first base portion and extending up to the first terminal, and
a plurality of first protrusion portions that protrude from the first base portion along the first wiring portion in a comb-like manner,
wherein the second terminal is arranged in the first base portion or one of the plurality of first protrusion portions,
wherein the second antenna element includes:
a second base portion included in a part of the loop,
a second wiring portion extending from the second base portion to the third terminal, and
a plurality of second protrusion portions that protrude from the second base portion along the second wiring portion in a comb-like manner, are arranged in a nested manner with the plurality of first protrusion portions, and constitute an interdigital portion that functions as a capacitor having a predetermined electrostatic capacitance, and
wherein the fourth terminal is arranged in one of the plurality of second protrusion portions or the second base portion.

6. The wireless communication device according to claim 5,
wherein the second terminal is coupled on a first side in a width direction of the loop antenna of the first base portion,
wherein one of the plurality of second protrusion portions is the second protrusion portion located at an end on the first side in the width direction of the loop antenna among the plurality of second protrusion portions, and
wherein the fourth terminal extends from a tip of the second protrusion portion located at the end in a direction to be away from the plurality of second protrusion portions.

7. An antenna device comprising:
a first terminal;
a second terminal;
a third terminal that corresponds to the first terminal, the first terminal and the third terminal being capable to couple to a first communication circuit having a first impedance and resonating at a first frequency; and
a fourth terminal that corresponds to the second terminal, the second terminal and the fourth terminal being capable to couple in parallel to a coil, a capacitor, and a second communication circuit having a second impedance lower than the first impedance and performing a communication at a second frequency,
wherein the antenna device constitutes a loop between the first terminal and the second terminal and the third terminal and the fourth terminal as a loop antenna.

8. The antenna device according to claim 7,
wherein the loop antenna includes a first antenna element and a second antenna element, the first antenna element and the second antenna element constituting the loop,
wherein the first antenna element includes:
a first base portion included in a part of the loop,
a first wiring portion protruding from the first base portion and extending up to the first terminal, and
a plurality of first protrusion portions that protrude from the first base portion along the first wiring portion in a comb-like manner,
wherein the second terminal is arranged in the first base portion or one of the plurality of first protrusion portions,
wherein the second antenna element includes:
a second base portion included in a part of the loop,
a second wiring portion extending from the second base portion to the third terminal, and
a plurality of second protrusion portions that protrude from the second base portion along the second wiring portion in a comb-like manner, are arranged in a nested manner with the plurality of first protrusion portions, and constitute an interdigital portion that functions as a capacitor having a predetermined electrostatic capacitance, and
wherein the fourth terminal is arranged in one of the plurality of second protrusion portions or the second base portion.

9. The antenna device according to claim 8,
wherein the second terminal is coupled on a first side in a width direction of the loop antenna of the first base portion,
wherein one of the plurality of second protrusion portions is the second protrusion portion located at an end on the first side in the width direction of the loop antenna among the plurality of second protrusion portions, and
wherein the fourth terminal extends from a tip of the second protrusion portion located at the end in a direction to be away from the plurality of second protrusion portions.
